(19) United States
(12) Patent Application Publication
(10) Pub. No.: US 2022/0222819 A1
(43) Pub. Date: Jul. 14, 2022

(54) CROP VIEW AND IRRIGATION MONITORING

(71) Applicant: Agtonomy, South San Francisco, CA (US)

(72) Inventors: Timothy Bucher, Geyserville, CA (US); Steven Holmes, Redwood City, CA (US)

(21) Appl. No.: 17/647,729

(22) Filed: Jan. 11, 2022

Related U.S. Application Data
(60) Provisional application No. 63/197,079, filed on Jun. 4, 2021.
(60) Provisional application No. 63/136,197, filed on Jan. 11, 2021.

(51) Int. Cl. G06T 7/00; H04N 7/18; A01G 25/16

(52) U.S. Cl. CPC G06T 7/0012; H04N 7/18; H04N 5/247; G06T 2207/30188; G06T 2207/30232; A01G 25/16

(57) ABSTRACT

An example monitoring system includes one or more cameras, one or more sensors, and data storage configured to store an image and a video from the one or more cameras and data from the one or more sensors.

The present application claims priority to U.S. Provisional Patent Application No. 63/136,197, filed on Jan. 11, 2021 and U.S. Provisional Patent Application No. 63/197,079, filed on Jun. 4, 2021. The entire contents of each of which are incorporated by reference in the present disclosure.

### FIELD

The present disclosure is generally directed towards crop view and irrigation monitoring.

### BACKGROUND

Unless otherwise indicated herein, the materials described herein are not prior art to the claims in the present application and are not admitted to be prior art by inclusion in this section.

Farming and agricultural ventures are often associated with labor intensive work and long hours. In some circumstances, long hours may be attributed to the large tracts of land and numerous crops that may be included in an operation. In some instances, large amounts of money and hours are spent managing various details of crops in an attempt to improve crop health and/or crop yield.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### BRIEF SUMMARY

In an embodiment, a monitoring system includes one or more cameras, one or more sensors, and a recording device configured to capture an image and a video from the one or more cameras and data from the one or more sensors.

These and other aspects, features and advantages may become more fully apparent from the following brief description of the drawings, the drawings, the detailed description, and appended claims.

### BRIEF DESCRIPTION OF THE DRAWINGS

Example embodiments will be described and explained with additional specificity and detail through the use of the accompanying drawings in which:

FIG. 1 is an example crop view capture and irrigation monitoring system;

FIG. 2 is a block diagram of an example system of the crop view capture and irrigation monitoring system of FIG. 1;

FIG. 3 illustrates a block diagram of an example computing system;

FIG. 4 illustrates a flowchart of an example method of determining a crop care action; and

FIG. 5 illustrates a flowchart of an example method of adjusting an irrigation system, all according to one or more embodiments of the present disclosure.

### DESCRIPTION OF EMBODIMENTS

Agricultural endeavors, including growing crops, may be a time intensive undertaking where regular monitoring may improve knowledge about the details of the crop and potentially, the crop yield. In some circumstances, acquiring information about any one crop, and subsequently the entire crop, may include examining each plant and its surrounding environment. In some circumstances, a record of the crop health and/or observed deficiencies may be recorded and may be compared to future examinations as a way to determine the crop health over time.

In instances in which a growing area is very large, and may include many crops, observing and/or sampling elements of each crop may be an overwhelming task. Further, the status of the crop(s) may change over time which may be observed only if the crop(s) are regularly monitored. In some circumstances, comparing the crop status and crop yield across multiple seasons may provide greater insight to the crop health, but may add complexity and additional time demands to an already time intensive process.

In some embodiments of the present disclosure, crop view and irrigation monitoring may provide an automated process for gathering crop information and the associated surrounding environment related to the crop, including irrigation and the like. Further, the crop view and irrigation monitoring may monitor both micro and macro levels of the crops, such as an individual crop and/or many crops on a parcel of land. Additionally, in some embodiments, crop view and irrigation monitoring may generate and/or provide a record of the details gathered related to an individual crop and/or many crops.

In some circumstances, embodiments of the present disclosure may facilitate improved crop health. Crop health may be enhanced by quickly observing defects, such as invasive bugs, too much or too little water and/or fertilizer, etc., which may lead to improved responses and better crop health. In some circumstances, regular monitoring and responsive actions may result in better crop yield due to healthier plants. Additionally, more information about both individual crops and the entire crop may contribute to more consistent and expected crop yields.

In the present disclosure, the term “crop” may refer to any plant product that may be grown. For example, the crops may include annual food crops, such as tomatoes, wheat, and the like, and/or perennial food crops, including fruit trees, such as apple trees, olive trees, and the like; nut trees such as almond trees, walnut trees, and the like; and vine crops, such as grapes, raspberries, and the like. Additionally or alternatively, crops may include ornamental and/or landscaping trees, bushes, shrubs; annual flowers; perennial flowers, and the like. Additionally or alternatively, crops may include natural vegetation such as un-cultivated forests, meadows, and/or other naturally occurring vegetation.

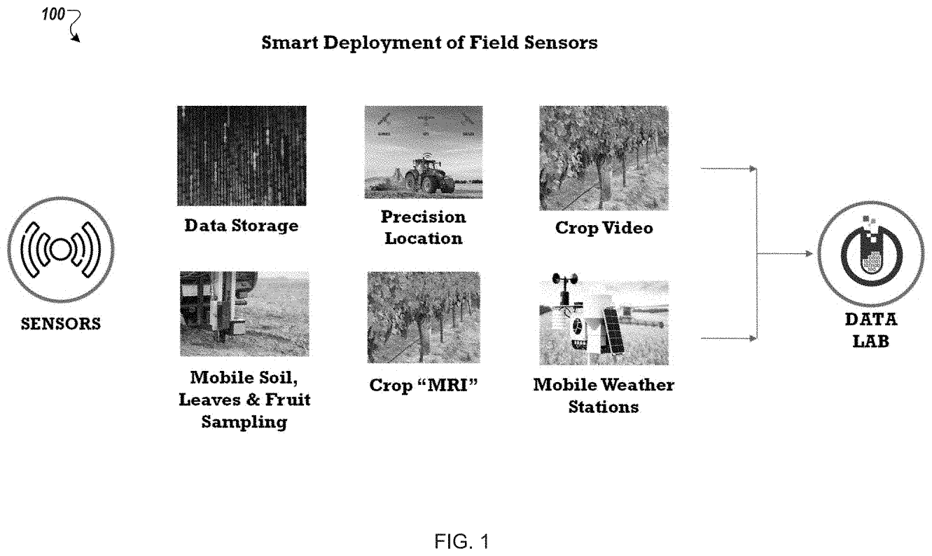

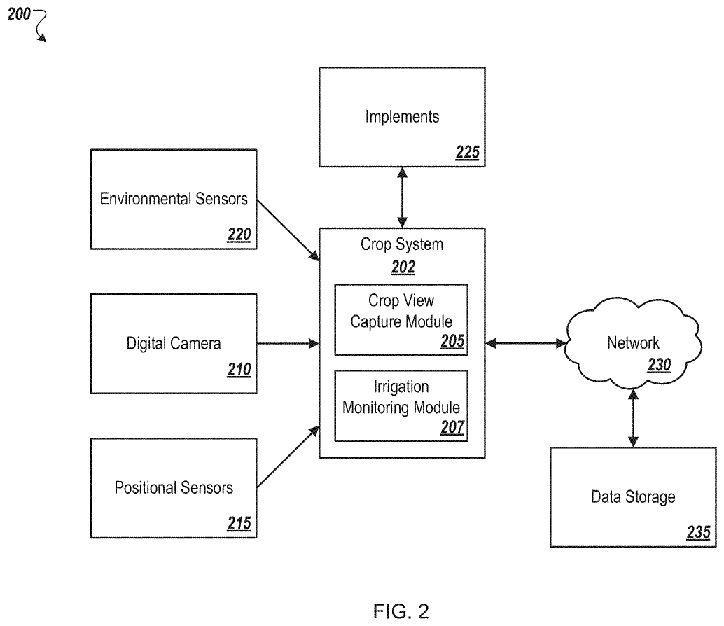

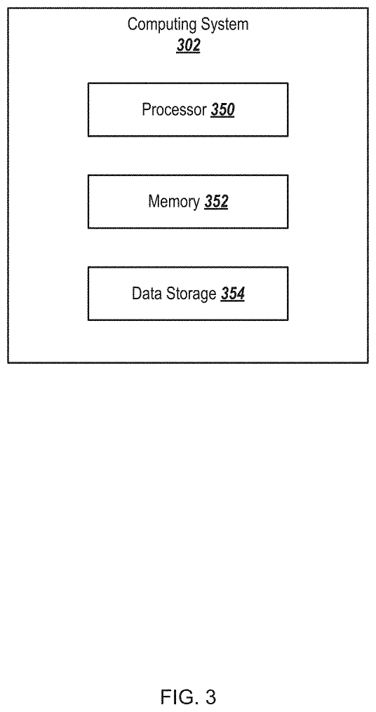

FIG. 1 is an example crop view capture and irrigation monitoring system 100, in accordance with at least one embodiment described in the present disclosure. The crop view capture and irrigation monitoring system 100 may include some or all of the components as discussed in conjunction with FIG. 2 and/or FIG. 3.

FIG. 2 is a block diagram of an example system 200 of the crop view capture and irrigation monitoring system 100 of FIG. 1, in accordance with at least one embodiment described in the present disclosure. The system 200 may include a crop system 202, a digital camera 210, positional sensors 215, environmental sensors 220, implements 225, a network 230, and a data storage 235. The crop system 202 may include a crop view capture module 205 and an irrigation monitoring module 207.

The crop view capture module 205 and/or the irrigation monitoring module 207 may include code and routines configured to enable a computing system to perform one or more operations. Additionally or alternatively, the crop view capture module 205 and/or the irrigation monitoring module 207 may be implemented using hardware including a processor, a microprocessor (e.g., to perform or control performance of one or more operations), a field-programmable gate array (FPGA), or an application-specific integrated circuit (ASIC). In some other instances, the crop view capture module 205 and/or the irrigation monitoring module 207 may be implemented using a combination of hardware and software. In the present disclosure, operations described as being performed by the crop view capture module 205 and/or the irrigation monitoring module 207 may include operations that the crop view capture module 205 and/or the irrigation monitoring module 207 may direct a corresponding system to perform. Further, although described separately in the present disclosure to ease explanation of different operations performed and roles, in some embodiments, one or more portions of the crop view capture module 205 and the irrigation monitoring module 207 may be combined or part of the same module.

In some embodiments, the operation of the crop system 202 and/or the operation of the subsystems of the crop system 202 (e.g., the crop view capture module 205 and/or the irrigation monitoring module 207) may be performed by a computing system, such as the computing system 302 of FIG. 3.

In some embodiments, the crop system 202 may obtain collected crop data from one or more different sources. In some embodiments, the collected crop data may include images of the crops and/or surrounding environment, video clips of the crops and/or surrounding environment, positional data related to the crops, environmental conditions relative to the crops and/or the crops surrounding environment, and/or other crop related data. In some embodiments, the collected crop data may be obtained from one or more sensors that may be configured to communicate with the crop system 202. For example, the collected crop data may be generated by one or more sensors including the digital camera 210, the positional sensors 215, the environmental sensors 220, the implements 225, and/or other sensors configured to detect conditions related to the crop system 202.

In some embodiments, the crop view capture module 205 may obtain images and/or video of the crops from the digital camera 210 and/or similar photographic device. In some embodiments, the images and/or video from the digital camera 210 may be included in the collected crop data related to the crops. The digital camera 210 may be configured to capture images of a single crop or of many crops. Alternatively or additionally, the digital camera 210 may be configured to capture one or more video clips of the single crop or the many crops. In some embodiments, the images may include a quality that may permit zooming in to see details of the crop. For example, image sizes may be at least 1280 pixels by 720 pixels. In some embodiments, the video clip may include a resolution that is sufficient to identify items of interest related to a crop, such as leaf color, number of blossoms, fruit status, pests (which may include a type of pest, an amount of the pests detected, a location of the pests, etc.), symptoms of disease, etc. For example, video resolution may be at least 1280×720 (720p).

In some embodiments, the crop view capture module 205 may include the images and/or video in the collected crop data. In some embodiments, the crop view capture module 205 may use the collected crop data to make determinations about the health and/or status of the crops. For example, the crop view capture module 205 may use the images and/or video from the digital camera 210 to observe various statuses of the crops including the number and type of bugs that may be present, the conditions of the blossoms, a ripeness amount of the fruit, the color of the leaves and/or the crop, amount of growth in the crop, potential diseases present, and/or other indications of crop health related to the crops.

In some embodiments, the digital camera 210 may be disposed on a vehicle, such as a tractor or a land drone, and/or vehicle related components (e.g., an implement, a trailer, etc.), and the digital camera 210 may be configured to capture images and/or video as the vehicle moves through the crops. Alternatively or additionally, the digital camera 210 may be disposed (e.g., mounted, placed, etc. in a fixed or detachable manner) in a fixed location and may be configured to capture images and/or video of the crops located nearby. For example, the digital camera 210 may be disposed on a stand, such as in a central portion of the crops, and may be configured to pan, tilt, and/or zoom to capture pictures of the crops. In some embodiments, such as instances in which the area of the land on which the crops are located is very large, many digital cameras 210 may be disposed in fixed locations throughout the crops, such that the many digital cameras 210 may capture and/or provide images and/or video of the crops to the crop view capture module 205.

In some embodiments, the digital camera 210 may be located above the crops, which may provide aerial images and/or video of the crops to the crop view capture module 205. For example, the digital camera 210 may be disposed on a drone, a UAV, a balloon, and/or other similar devices capable of capturing elevated images and/or video.

In these and other embodiments, images and/or video of the crops may be obtained from a combination of one or more digital cameras 210 disposed in different locations. For example, images and/or video of the crops may be obtained by the crop view capture module 205 from a digital camera 210 on a tractor, a digital camera 210 on a stand, and/or a digital camera 210 on an aerial drone.

In some embodiments, the crop view capture module 205 may obtain positional data related to the crops from the positional sensors 215. For example, the crop view capture module 205 may obtain positional data from one or more of a GPS, one or more accelerometers, one or more gyroscopes, and/or one or more visual references or fixed waypoints that may be detected by another sensor, such as the digital camera 210. In some embodiments, the positional data from the positional sensors 215 may be included in the collected crop data related to the crops. In some embodiments, the crop view capture module 205 may receive coordinates from the GPS and associate the coordinates with a crop. Alternatively or additionally, coordinates may be associated with the crops prior to being received by the crop view capture module 205. For example, an image and/or video from the digital camera 210 may include positional information such as from the positional sensors 215 that may be used to identify the location of the crops included in the image and/or video. In some embodiments, the one or more accelerometers, and/or one or more gyroscopes may provide positional information to the crop view capture module 205 such as height above ground, distance from the center of the crop, distance to nearest adjacent crop, etc., such that particular branches and/or elements of the crop may be determined. For example, in instances in which the crop view capture module 205 identifies a blight on a limb of a crop, such as from provided images and/or video from the digital camera 210, coordinates may be determined by the positional sensors 215 and the coordinates may be saved and/or shared with a proprietor such that the proprietor may quickly locate the crop and/or the limb with the blight.

In some embodiments, the positional sensors 215 may be disposed on the vehicle, such as a tractor or a land drone, and/or the vehicle related components (e.g., an implement, a trailer, etc.), and the positional sensors 215 may be configured to capture positional data as the vehicle moves through the crops. Alternatively or additionally, the positional sensors 215 may be co-located with the digital camera 210 in the various locations the digital camera 210 may be located, such that images and/or video captured from the digital camera 210 may include positional data from the positional sensors 215.

In some embodiments, the crop view capture module 205 may obtain environmental data related to the crops from the environmental sensors 220. The environmental sensors 220 may be in the alternative or supplementary to the digital camera 210 and/or the positional sensors 215. In some embodiments, the environmental data from the environmental sensors 220 may be included in the collected crop data related to the crops. The environmental sensors 220 may include such sensors as optical sensors, electro-chemical sensors, mechanical sensors, dielectric soil moisture sensors, air flow sensors, and/or other similar sensors for detecting various aspects of an environment. In some embodiments, one or more of the environmental sensors 220, either singly or in combination, may be configured to detect soil compositions including amounts of organic and inorganic matter, amounts of minerals and/or nutrients present, amounts of clay, silt, and/or sand, and/or other soil compositions; pH and soil nutrient levels; soil compaction; soil moisture levels; and/or air permeability.

In some embodiments, the crop view capture module 205 may use the received environmental data as part of the collected crop data to determine an overall health of the crops. Alternatively or additionally, the crop view capture module 205 may use the received environmental data to predict a future health of the crops. In these and other embodiments, the crop view capture module 205 may use the environmental data from the environmental sensors 220 in conjunction with the collected crop data to determine potential actions to take that may improve the health of the crops. For example, in instances where the environmental sensors 220 detect a low amount of nutrients, the crop view capture 205 may provide an indication to increase an amount of fertilizer to the crops.

In some embodiments, the environmental sensors 220 may be disposed in similar locations as the digital camera 210. For example, the environmental sensors 220 may be disposed on the vehicle, such as a tractor or a land drone, and/or the vehicle related components (e.g., an implement, a trailer, etc.). Alternatively or additionally, the environmental sensors 220 may be disposed in a fixed position on or in the parcel of land surrounding the crops. Alternatively or additionally, the environmental sensors 220 may be configured to capture environmental data in an aerial location. For example, the environmental sensors 220 may be disposed on a drone, a UAV, a balloon, and/or other similar devices that may capture environmental data from an aerial location.

In some embodiments, the collected crop data for a crop may be analyzed by the crop view capture module 205 to determine an overall health of the crop. For example, the crop view capture module 205 may compare a current image of a crop to a prior image of a crop and may determine a level of progression (or regression) in the crop. Alternatively or additionally, the crop view capture module 205 may compare an image of a first crop to an image of a second crop and may determine that the first crop is progressing better than the second crop. The crop view capture module 205 may compare the environmental data from the environmental sensors 220 between the first crop and the second crop and may determine that an environmental factor may be contributing the difference in health of the first crop and the second crop. In some embodiments, the crop view capture module 205 may use the collected crop data to determine time sensitive crop statuses, such as a readiness of the crop fruit to harvest and/or veraison. Alternatively or additionally, the crop view capture module 205 may use the collected crop data to predict time sensitive crop statuses, such as determining a potential window of when the crop fruit may be ready to harvest. In these and other embodiments, the crop view capture module 205 may be configured to provide the results of the determined overall crop health and/or crop statuses to the proprietor or other user of the crop view capture module 205.

In some embodiments, different aspects related to crop health may be weighted and/or scored by the crop view capture module 205, such as using the collected crop data gathered by the various sensors of the system 200 (e.g., the digital camera 210, the positional sensors 215, and/or the environmental sensors 220), which may provide an overall crop health metric. For example, a number of blights detected by the digital camera 210 on a crop may be given a lower score and a greater weight by the crop view capture module 205, while an even green color on the leaves of the crop may be given a higher score and a lesser weight by the crop view capture module 205, such that the crop view capture module 205 may provide an indication that the crop health may need improvement. In some embodiments, different aspects related to the crop health that may be captured by the various sensors may include number and/or types of bugs present; observed blights on branches, stems, leaves, and/or fruit; other observable plant diseases; color of leaves, fruit, and/or stalks or branches; and/or soil conditions including compaction, and/or moisture levels.

In some embodiments, the different aspects may be weighted by the crop view capture module 205 according to metrics that carry greater importance to crop health. For example, the crop view capture module 205 may assign a smaller weight to a number of bugs detected by the digital camera 210 than the weight assigned to observed blights by the digital camera 210. Alternatively or additionally, the crop view capture module 205 may include variable weights that may be set as desired by the proprietor or other user of the crop view capture module 205. In some embodiments, the proprietor or other user may provide an input to the crop view capture module 205 that the weights assigned to the different aspects related to the crop health should be adjusted, and the crop view capture module 205 may update the overall crop health metric to include the changes to the user inputted weights. For example, the proprietor or other user may input a smaller weight for the color of the leaves of the crop and the crop view capture module 205 may update the overall crop health metric to reflect the adjusted weight.

In some embodiments, the crop view capture module 205 may group the overall crop health metric into categories to quickly indicate the overall health of the crop. For example, in instances in which a scale of one through ten is used for the overall crop health metric, ratings of eight to ten may be grouped by the crop view capture module 205 to include a green indication, ratings of five to seven may be grouped by the crop view capture module 205 to include a yellow indication, and ratings of zero to four may be grouped by the crop view capture module 205 to include a red indication. There may be more or less categories the ratings may be grouped into and the size of the scale may also vary or be altered for more or less precision. In these and other embodiments, the collected crop data representative of the overall health of the crop may be provided by the crop view capture module 205 to be quickly viewed to determine a crop and/or crops that may benefit from additional care.

In some embodiments, the crop view capture module 205 may aggregate the collected crop data (e.g., images and/or video, positional data, and/or environmental data from the digital camera 210, the positional sensors 215, and/or the environmental sensors 220, respectively) for a single crop into aggregate collected crop data for all crops located within the parcel of land. For example, in instances in which crops are planted across one square acre, the collected crop data for all crops on the acre may be aggregated by the crop view capture module 205 into the aggregate collected crop data. The parcel of land for crops may be smaller or larger, such as partitions of an acre up to tens or thousands of acres.

In some embodiments, a digital overhead view of the parcel of land and the crops thereon may be obtained by the crop view capture module 205 that may be used in conjunction with the collected crop data. In some embodiments, the digital overhead view may be provided from satellite imagery. Alternatively or additionally, the digital overhead view may be captured from a UAV, a remote-controlled drone, and/or other similar flying devices capable of capturing a digital image. In these and other embodiments, the digital overhead view may be transmitted to the crop view capture module 205 and may be used in conjunction with the collected crop data. In some embodiments, the digital overhead view may include image quality sufficient to zoom in enough to see an individual crop and/or zoom out enough to see all the crops on the parcel of land.

In some embodiments, the crop view capture module 205 may combine the aggregated crop data from the collected crop data with an aggregation of the overall crop health metrics for all of the crops included in the parcel of land. In some embodiments, the aggregation of overall crop health metrics by the crop view capture module 205 may be combined with the positional data from the positional sensors 215 by the crop view capture module 205 to provide a heat map that may provide insights into the health of crops by location. In some embodiments, the heat map generated by the crop view capture module 205 may include a combination of the digital overhead view obtained by the crop view capture module 205 and the overall crop health metric as determined by the crop view capture module 205. For example, the crop view capture module 205 may determine a heat map that may include the overall crop health metric which may be superimposed on the digital overhead view. The heat map superimposed on the digital overhead view by the crop view capture module 205 may provide a visual indication of the crop health that may be tied to the location where the overall crop health is detected.

In some embodiments, the heat map generated by the crop view capture module 205 may provide indications of local and/or global issues related to the crops. For example, in instances in which the crop view capture module 205 determines the crops on a portion of the parcel of land indicates yellow or red crop health (e.g., as described above), the crop view capture module 205 may detect a distinct issue exists to the detriment of some of the crops, such as improper irrigation, or a localized pest problem. In another example, in instances in which the crop view capture module 205 determines all of the crops in the parcel of land indicate yellow or red crop health, the crop view capture module 205 may detect a general issue exists to the detriment of all the crops, such as improper fertilization, or an unconfined pest problem.

In some embodiments, the crop view capture module 205 may be configured to wirelessly communicate over the network 230. For example, crop view capture module 205 may include additional systems and/or devices to communicate over the network 230 via wireless channels including Wi-Fi, WiMAX, Bluetooth®, cellular communications, and/or other wireless technologies. For example, the collected crop data from the crop view capture module 205 may be wirelessly uploaded over the network 230 to a network attached storage, such as a cloud storage device or other data storage 235. Alternatively or additionally, the collected crop data from the crop view capture module 205 may be stored locally with the crop view capture module 205 until the collected crop data may be downloaded to another system, such as the data storage 235, which may be located at an associated docking station.

In some embodiments, the crop view capture module 205 may be configured to communicate over the network 230 with a mobile application. For example, the crop view capture module 205 may provide updates of the collected crop data to a mobile application of a mobile device, such as a mobile phone, tablet, personal computer, and/or other mobile devices. In some embodiments, the operation of the network 230 may be performed by a computing system, such as the computing system 302 of FIG. 3.

In some embodiments, the crop view capture module 205 may be included in an autonomous device and/or autonomous system that may be configured to automate processes, such as a crop management process. In these and other embodiments, the collected crop data obtained by the crop view capture module 205 may be used as part of the crop management. For example, in instances in which a disease is detected by the crop view capture module 205 on a branch of a crop, such as from images and/or video from the digital camera 210, the associated autonomous device and/or autonomous system may prune the diseased branch, provide a notification of the pruning, and/or schedule reminders for future observation of the crop. In some embodiments, the autonomous device and/or autonomous system may be configured to manage the crops without user input. Alternatively or additionally, the autonomous device and/or autonomous system may wait for and/or request user authorization to advance the related crop management, prior to taking any action beyond observing and/recording the crops. Alternatively or additionally, the crop view capture module 205 may be configured to determine, track, and/or monitor the results of scheduled interventions, such as pruning, spraying, and/or other crop management tasks. In some embodiments, the scheduled interventions may be performed by the proprietor, the autonomous vehicle, and/or other parties associated with observing and maintaining the crop health.

In some embodiments, the implements 225 may be used in conjunction with the crop view capture module 205 and the autonomous device and/or the autonomous system to capture additional data that may be included in the collected crop data. For example, the implements 225 and/or sensors may be included to sample the soil, determine a weed density, pick and sample leaves from a crop, and/or other actions to gather additional crop or associated environmental information which may be provided to the crop view capture module 205.

In some embodiments, the implements 225 of the autonomous device and/or the autonomous system may include an implement configured to produce subterranean x-rays, which may be provided to the crop view capture module 205. For example, a crop root x-ray may be occasionally taken and included in the collected crop data and may be provided to the crop view capture module 205. The crop view capture module 205 may compare a current crop root x-ray with subsequent crop root x-rays which may enable the crop view capture module 205 to develop a more comprehensive view of the crop root health and/or the overall crop health. In some embodiments, the crop root x-ray may enable the crop view capture module 205 to identify diseases and/or other issues in the crop roots prior to observing the resultant diseases and/or other issues in the crop. For example, in instances in which a crop root has a j-rooting problem, the crop root x-ray may enable the crop view capture module 205 to identify the problem via crop root x-ray, where the j-rooting problem might not have otherwise been discoverable for many months or years.

In some embodiments, the digital camera 210 and/or environmental sensors 220 may be configured to monitor and/or record irrigation data related to an irrigation system, such as permanent irrigation lines. Alternatively or additionally, the irrigation data may be obtained by the irrigation monitoring module 207 cameras and/or sensors which may be distinct from the digital camera 210 and/or environmental sensors 220 that are used for the collected crop data obtained by the crop view capture module 205. For example, an infrared (IR) sensor may send irrigation data to the irrigation monitoring module 207, that may be used to observe and/or estimate an irrigation rate, a water absorption amount by the crops, and/or other related irrigation data. The irrigation system may include drip irrigation, surface irrigation, various forms of sprinkler irrigation, and/or other irrigation systems and/or pipes that may connect the different sprinklers and/or emitters. In some embodiments, the digital camera 210 and/or the environmental sensors 220 may be configured to detect an amount of water being delivered to a crop to include in the irrigation data, and may deliver the irrigation data to the irrigation monitoring module 207. For example, in instances in which drip irrigation is used, the digital camera 210 and/or the environmental sensors 220 may observe drips from an emitter to include in the irrigation data and deliver the irrigation data to the irrigation monitoring module 207. Further, the irrigation monitoring module 207 may calculate drips per hour being delivered to the crop from the emitter based on the irrigation data.

In some embodiments, the irrigation data may include positional information analogous to the positional information of the collected crop data. Alternatively or additionally, the positional information of the irrigation data may be generated by the same or analogous sensors as the positional information from the crop data.

In some embodiments, the irrigation monitoring module 207 may associate the irrigation data of a particular crop with the collected crop data gathered from the crop view capture module 205 of the same crop. In some embodiments, the irrigation data and the collected crop data may be associated to the same crop by the irrigation monitoring module 207 and/or the crop view capture module 205 as the irrigation data and the collected crop data were captured at the same time. Alternatively or additionally, the irrigation data and the collected crop data may be associated to the same crop by the irrigation monitoring module 207 and/or the crop view capture module 205 using the positional information from the positional sensors 215. In instances in which the irrigation data and the collected crop data is associated by positional information by the irrigation monitoring module 207 and/or the crop view capture module 205, the association may occur because the positional information for a crop is the same or within a small margin such that it is determined to be the same crop. In some embodiments, the irrigation data may contribute to the overall crop health metric for a single crop and/or for the entire crop, as determined by the irrigation monitoring module 207 and/or the crop view capture module 205.

In some embodiments, the digital camera 210 may be configured to detect nutrients, such as fertilizers, delivered to the crops through the irrigation system, which may be included in the irrigation data provided to the irrigation monitoring module 207. For example, in instances in which the nutrients include visible and/or detectable particulates, the digital camera 210 may observe and/or record the amount of nutrients delivered to a crop and include the results in the irrigation data that may be provided to the irrigation monitoring module 207. Alternatively or additionally, in instances in which the nutrients include water soluble components, a dye may be added to the nutrients, which may be detected by the digital camera 210. In instances in which a dye is added to the nutrients, the digital camera 210 may be configured to detect an opacity level of the observed dye which may indicate the amount of nutrients delivered to a crop. The amount of delivered nutrients may be included in the irrigation data that may be provided to the irrigation monitoring module 207. For example, in instances in which more nutrients are delivered by the irrigation system, the color of the dye may be more saturated which may indicate the greater amount of nutrients are being delivered. In these and other embodiments, the observed nutrient delivery may be included in the irrigation data, which may be associated by the irrigation monitoring module 207 and/or the crop view capture module 205 with the collected crop data related to a single crop or for the many crops.

In some embodiments, the environmental sensors 220 may be configured to produce irrigation data for use by the irrigation monitoring module 207. For example, the environmental sensors 220 may be configured to sample soil surrounding the crops to determine a moisture level of the soil before, during, and/or after irrigation. The soil moisture level may be included in the irrigation data and may be provided to the irrigation monitoring module 207. Alternatively or additionally, the environmental sensors 220 may detect surrounding weather conditions that may contribute to the effectiveness of the irrigation. For example, the environmental sensors 220 may provide an amount of sunlight, wind, humidity, and/or other factors to include in the irrigation data, which the irrigation monitoring module 207 may use to determine an effectiveness of irrigation under various weather and/or climate conditions.

In some embodiments, the irrigation data, which may include nutrient data, gathered by the digital camera 210 and/or the environmental sensors 220 and obtained by the irrigation monitoring module 207 may be recorded and/or stored in the data storage 235. Alternatively or additionally, the irrigation data may be associated with the collected crop data by the irrigation monitoring module 207 and/or the crop view capture module 205 and jointly stored in the data storage 235. In some embodiments, the irrigation data may be analyzed and/or presented to the proprietor. For example, the irrigation monitoring module 207 may determine from the irrigation data that an individual crop and/or a portion of crops may be receiving less irrigation than anticipated. In some embodiments, the irrigation monitoring module 207 and/or the crop view capture module 205 may include the irrigation data as part of the heat map related to the crops. Alternatively or additionally, the irrigation monitoring module 207 and/or the crop view capture module 205 may enable filtering of the irrigation data in the heat map such that the heat map may display a status and/or issues related to irrigation. For example, the heat map, as determined by the irrigation monitoring module 207 and/or the crop view capture module 205, may include a filter option where the proprietor may choose to view the irrigation data, which may indicate local or general issues related to over-watering, under-watering, over-fertilization, under-fertilization, and/or similar irrigation issues.

In some embodiments, the irrigation monitoring module 207 may be configured to wirelessly communicate over the network 230. For example, irrigation monitoring module 207 may include additional systems and/or devices to communicate over the network 230 via wireless channels including Wi-Fi, WiMAX, Bluetooth®, cellular communications, and/or other wireless technologies. In some embodiments, irrigation monitoring module 207 may be configured to communicate over the network 230 with a mobile application. For example, the irrigation monitoring module 207 may provide updates of the irrigation data to a mobile application of a mobile device, such as a mobile phone, tablet, personal computer, and/or other mobile devices.

In some embodiments, the irrigation monitoring module 207 may be configured to communicate with a communication device and/or system, such as a device to communicate over the network 230 as described above, to provide an alert to the proprietor and/or user related to the irrigation system. For example, in instances in which a broken emitter and/or a broken irrigation line is detected by the irrigation monitoring module 207 based on the irrigation data, the communication device and/or system may send a real-time message to the proprietor and/or user indicating the issue detected by the irrigation monitoring module 207 and the location thereof.

In some embodiments, the irrigation monitoring module 207 may be included in an autonomous device and/or autonomous system that may be configured to automate processes, such as an irrigation system management process. In these and other embodiments, the irrigation data obtained by the irrigation monitoring module 207 may be used as part of the irrigation system management. For example, in instances in which a broken emitter is detected by the irrigation monitoring module 207, such as from images and/or video from the digital camera 210, the associated autonomous device and/or autonomous system may remove the broken emitter, install a new emitter, and/or verify proper irrigation by the new emitter. In some embodiments, the autonomous device and/or autonomous system may be configured to manage the irrigation system without user input. Alternatively or additionally, the autonomous device and/or autonomous system may wait for and/or request user authorization before making any changes to the irrigation system. In some embodiments, the operation of the network 230 may be performed by a computing system, such as the computing system 302 of FIG. 3.

The crop view capture module 205 and/or the irrigation monitoring module 207 may be included in a standalone device, such as the system 202 and/or multiple standalone devices, that may be carried around by the proprietor or another user. Alternatively or additionally, the one or more devices may be attached to an existing agricultural vehicle, such as a tractor.

FIG. 3 illustrates a block diagram of an example computing system 302, according to at least one embodiment of the present disclosure. The computing system 302 may be configured to implement or direct one or more operations associated with a crop system and/or a network (e.g., the crop system 202 and/or the network 230 of FIG. 2). The computing system 302 may include a processor 350, a memory 352, and a data storage 354. The processor 350, the memory 352, and the data storage 354 may be communicatively coupled.

In general, the processor 350 may include any suitable special-purpose or general-purpose computer, computing entity, or processing device including various computer hardware or software modules and may be configured to execute instructions stored on any applicable computer-readable storage media. For example, the processor 350 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 3, the processor 350 may include any number of processors configured to, individually or collectively, perform or direct performance of any number of operations described in the present disclosure. Additionally, one or more of the processors may be present on one or more different electronic devices, such as different servers.

In some embodiments, the processor 350 may be configured to interpret and/or execute program instructions and/or process data stored in the memory 352, the data storage 354, or the memory 352 and the data storage 354. In some embodiments, the processor 350 may fetch program instructions from the data storage 354 and load the program instructions in the memory 352. After the program instructions are loaded into memory 352, the processor 350 may execute the program instructions.

For example, in some embodiments, any one of the modules described herein may be included in the data storage 354 as program instructions. The processor 350 may fetch the program instructions of a corresponding module from the data storage 354 and may load the program instructions of the corresponding module in the memory 352. After the program instructions of the corresponding module are loaded into memory 352, the processor 350 may execute the program instructions such that the computing system may implement the operations associated with the corresponding module as directed by the instructions.

The memory 352 and the data storage 354 may include computer-readable storage media for carrying or having computer-executable instructions or data structures stored thereon. Such computer-readable storage media may include any available media that may be accessed by a general-purpose or special-purpose computer, such as the processor 350. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 350 to perform a certain operation or group of operations.

Modifications, additions, or omissions may be made to the computing system 302 without departing from the scope of the present disclosure. For example, in some embodiments, the computing system 302 may include any number of other components that may not be explicitly illustrated or described.

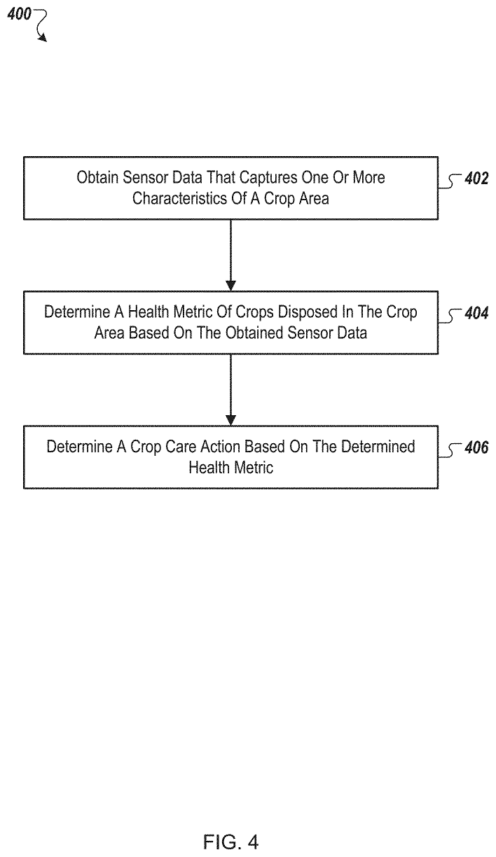

FIG. 4 illustrates an example flowchart of an example method 400 of determining a crop care action, described according to at least one embodiment of the present disclosure. The method 400 may be performed by any suitable system, apparatus, or device. For example, one or more of the operations of the method 400 may be performed by a module such as the crop view module or the irrigation module of FIG. 2 and/or a computing system such as described with respect to FIG. 3.

At block 402, sensor data that indicates one or more characteristics of a crop area may be obtained. For example, in some embodiments, the sensor data may include data obtained from environmental sensors, such as those described with respect to FIG. 2 and the related data described therewith. In these or other embodiments, the sensor data may include positional data obtained from one or more positional sensors, such as described above with respect to FIG. 2. In these or other embodiments, one or more images and/or video may be obtained at block 402.

At block 404, a health metric of crops disposed in the crop area may be determined. In some embodiments, the health metric may be determined based on the data obtained at block 402. Additionally or alternatively, the health metric and determinations associated therewith may correspond to any of those described above with respect to FIG. 2 in relation to crop status.

At block 406, a crop care action may be determined based on the determined health metric. The actions and corresponding determinations described above with respect to FIG. 2 in relation to crops are example crop care actions and determinations. In these or other embodiments, the method 400 may include directing operation of the determined crop care action. For example, controlling a system to implement the determined crop care action.

Modifications, additions, or omissions may be made to the method 400 without departing from the scope of the present disclosure. For example, the order of one or more of the operations described may vary than the order in which they were described or are illustrated. Further, each operation may include more or fewer operations than those described. For example, any number of the operations and concepts described above with respect to FIG. 2 may be included in or incorporated by the method 400. In addition, the delineation of the operations and elements is meant for explanatory purposes and is not meant to be limiting with respect to actual implementations.

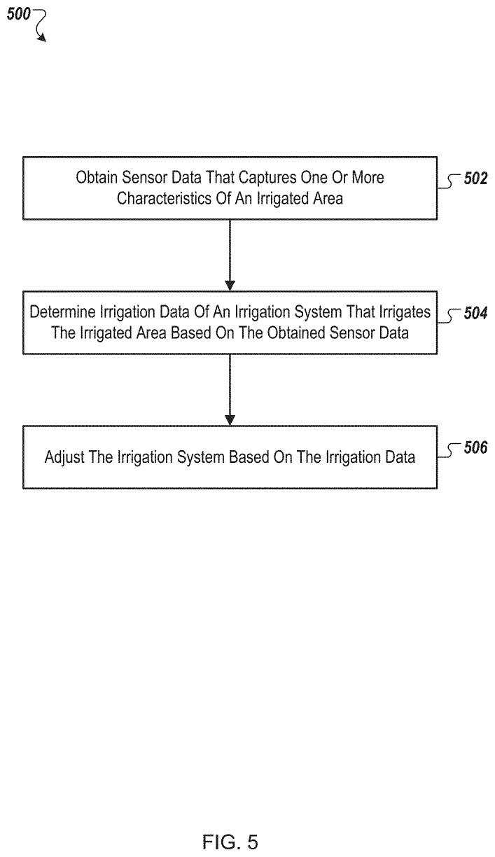

FIG. 5 illustrates an example flowchart of an example method 500 of adjusting an irrigation system, described according to at least one embodiment of the present disclosure. The method 500 may be performed by any suitable system, apparatus, or device. For example, one or more of the operations of the method 500 may be performed by a module such as the crop view module or the irrigation module of FIG. 2 and/or a computing system such as described with respect to FIG. 3.

At block 502, sensor data that indicates one or more characteristics of an irrigation area may be obtained. For example, in some embodiments, the sensor data may include data obtained from environmental sensors, such as those described with respect to FIG. 2 and the related data described therewith. In these or other embodiments, the sensor data may include positional data obtained from one or more positional sensors, such as described above with respect to FIG. 2. In these or other embodiments, one or more images and/or video may be obtained at block 502. Further, any data described above with respect to FIG. 2 that may relate to characteristics of irrigation systems and corresponding areas may be obtained.

At block 504, irrigation data of an irrigation system that irrigates the irrigation area may be determined. In some embodiments, the irrigation data may be determined based on the data obtained at block 502. Additionally or alternatively, the irrigation data and determinations associated therewith may correspond to any of those described above with respect to FIG. 2 in relation to status of an irrigation system.

At block 506, the irrigation system may be adjusted based on the determined irrigation data. Adjusting the irrigation system may include providing a recommended action with respect to the irrigation system. Additionally or alternatively, adjusting the irrigation system may include implementing an action or causing the implementation of an action with respect to the irrigation system. The actions and corresponding determinations described above with respect to FIG. 2 in relation to irrigation systems are example irrigation actions and determinations.

Modifications, additions, or omissions may be made to the method 500 without departing from the scope of the present disclosure. For example, the order of one or more of the operations described may vary than the order in which they were described or are illustrated. Further, each operation may include more or fewer operations than those described. For example, any number of the operations and concepts described above with respect to FIG. 2 may be included in or incorporated by the method 500. In addition, the delineation of the operations and elements is meant for explanatory purposes and is not meant to be limiting with respect to actual implementations.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” This interpretation of the phrase “A or B” is still applicable even though the term “A and/or B” may be used at times to include the possibilities of “A” or “B” or “A and B.” All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure. Accordingly, the scope of the invention is intended to be defined only by the claims which follow.

What is claimed is:

1. A monitoring system comprising:
one or more cameras;
one or more sensors;
data storage configured to capture an image and a video from the one or more cameras and data from the one or more sensors; and
a computing system configured to perform operations, the operations comprising:
obtaining data related to a crop area from the data storage, the data including one or more of:
the image,
the video, or
the sensor data,
determining a health metric of crops disposed in the crop area based on the obtained data; and
determining a crop care action based on the determined health metric.
